(19) United States
(12) Patent Application Publication
(10) Pub. No.: US 2005/0043075 A1
(43) Pub. Date: Feb. 24, 2005

(54) COMPUTER GAME WITH MATCHABLE BLOCKS

(76) Inventors: Liang-Yu Lin, Taipei City (TW); Wen-Yen Chen, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/604,797

(22) Filed: Aug. 18, 2003

(51) Int. Cl. A63F 13/00

(52) U.S. Cl. 463/9

(57) ABSTRACT

A playing grid includes cells for holding objects of different types, and a cursor that when moved exchanges positions in the grid with an adjacent object. The cursor is prevented from leaving the bounds of the grid. Horizontally or vertically lined-up matchable objects of the same type are deleted. Objects are moved in the grid to cells adjacent to and below unless occupied by other objects. A new row of objects is created below the bottommost row of the playing grid, and shifted up into the grid displacing other objects in the grid up. In an expert mode, falling objects are created at the top of the grid, and objects can be transformed into other objects. In a multiplayer mode, objects can be exchanged and deleted from two playing grids depending on player performance.

### BACKGROUND OF INVENTION

1. Field of the Invention

The present invention relates to digital electronics, and more specifically, to a computer game.

2. Description of the Prior Art

Computer games are a widely popular form of entertainment. Before achieving such popularity, computer games where mainly played by hobbyists, who often programmed the games themselves, and children. From the first computer game, “Spacewar” written by Steve Russell in 1962 for the DEC PDP-1, to more recent and immersive games written for specially designed 3-D graphics accelerators and modern computers, games have become increasingly appealing to the public. Though entertainment may have been the original motivation behind developing computer games, more and more people are finding that games can be a source of intellectual stimulation and relaxation. Furthermore, computer games can even be used to realize business or sociological simulations. These days, in societies where computers and other game-capable electronic hardware are commonplace, it is difficult to find someone who has never played such a game.

Parallel to the increasing development of computer games, computer hardware is undergoing refinements and new developments. In the 1990s, computer games were commonly found on desktop or notebook computers, on game consoles adapted for home television sets, and in larger specialized consoles for game arcades. However, more recently, and made possible by significant advancements in component miniaturization, computer games are now playable on smaller devices such as mobile phones, personal digital assistants (PDAs), and the like. These advancements in hardware have widened the range of players of computer games. For example, one can now readily spot a subway commuter or two enjoying games on their mobile phones, where 20 years ago such pastime was only to be had by teenagers on home computers or in darkened video arcades.

Part of the wide appeal of computer games stems from the wide variety available. Games range from near realistic to highly abstract, with all kinds being potentially enjoyable.

A genre of abstract game that has been found to be enjoyable by many is the block-based game. A popular game in this category is “Tetris”, originally created by Alexey Pazhitnov but having been implemented in many subsequent variations. In “Tetris”, a player must maneuver (translate and rotate) varied and odd-shaped falling blocks such that the blocks form complete rows in the playing grid. When the player makes a complete row, the blocks of that row are deleted and points are awarded. Another example of an abstract block-based game, which also doubles as an intelligence-trainer, is taught by Mraovic in U.S. Pat. No. 6,579,177. Numerous other block-based games can be found on the Internet, at software retailers, or bundled with portable electronic devices. Part of the appeal of block-based games is that they are generally easy to learn, requiring little complexity in input, but are difficult to master.

The relatively simple characteristic of block-based games coupled with their wide appeal is what makes games of this genre well suited for mass produced portable consumer devices such as a mobile phones and PDAs. Given the small and somewhat cramped input means of such portable devices and the wide variety of people who use them, it is a significant challenge to develop an exciting and stimulating block-based game.

### SUMMARY OF INVENTION

It is therefore a primary objective of the claimed invention to provide a method for a computer game that is easy and exciting to play on a mobile device.

Briefly summarized, the claimed invention provides a playing grid comprising rows and columns of cells for holding objects, each object having a type, and a cursor that when moved exchanges positions in the grid with an adjacent object, the cursor being prevented from leaving the bounds of the grid. The steps of the method include deleting horizontally or vertically lined-up objects of the same type when the number of the lined-up objects of the same type is equal to a second number and the type is matchable, moving each object in the grid to a cell adjacent to and below the object unless that cell is occupied by another object or the object is in the bottommost row, creating a new row of objects below the bottommost row of the playing grid, and shifting the new row of objects up into the grid and shifting all other objects in the grid up to accommodate the new row.

According to the claimed invention, transformable objects can be provided, the transformable objects capable of being transformed into matchable objects. In addition, the method can further create objects of randomly selected types in cells of the topmost row of randomly selected columns at random intervals.

According to the claimed invention, the method can be adapted to two independent playing grids for two players. The steps of the method can be executed independently for each playing grid, and can further comprise: creating at least an object of randomly selected type in a cell of the top most row of a randomly selected column of the playing gird when deleting horizontally or vertically lined-up objects of the same type in the other playing grid.

It is an advantage of the claimed invention that the computer game method can be used for entertainment, as an intelligence test, or as a test of hand-eye coordination.

It is a further advantage of the claimed invention that the method is suitable for a small portable electronic device.

It is a further advantage of the claimed invention that the method allows two players to play the game competitively.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a general game screen according to the present invention.

FIGS. 2-7 are schematic diagrams of states of the playing grid of FIG. 1.

FIG. 8 is a schematic diagram the game of FIG. 1 in an expert mode.

FIG. 9 is a flowchart of a general game method according to the present invention.

FIG. 10 is a schematic diagram of a multiplayer embodiment of the present invention

### DETAILED DESCRIPTION

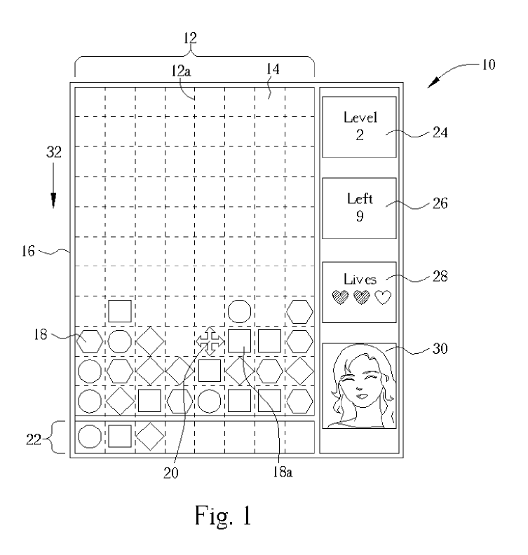

Please refer to FIG. 1 illustrating two-dimensional graphics of a game 10. The game 10 is a general view of the computer game method according to the present invention. The game 10 can be easily rendered on the display of a portable device, such as a mobile phone, or on the screen of a typical computer. Preferably, the game 10 is used in a single player mode of the present invention game method.

The game 10 includes a rectangular grid 12 of cells 14 defined by grid lines 12a, which are preferably not rendered and are only shown to aid understanding of the invention. The grid 12 is set into a frame 16 that bounds the playing area of the game 10. The cells 14 form rows and columns, eleven columns and eight rows being shown as an example. The cells 14 are capable of holding objects 18 of different types, each type being identified by a shape such as: square, circle, diamond, and hexagon; however, other shapes are possible and types may even be differentiated by color. The cells 14 are also capable of holding a cursor 20 that is movable by a player though an input means (keypad, joystick, touchpad, etc) of the portable device or computer. The cursor 20 can be moved left, right, up, and down (direction of arrow 32) within the bounds of the grid 12. Furthermore, when moved, the cursor 20 must switch places with an object 18. That is, the cursor 20 at the position illustrated in FIG. 1 can be moved right to exchange positions with the square 18a, but cannot be moved up as there is no object in the grid above the cursor 20 with which to exchange positions. Further provided in the game 10 are a new object row 22 (below the bottommost row of the grid 12) for introducing more objects 18 into the grid 12, a level indicator 24, a target indicator 26, a lives indicator 28, and a player portrait 30, which will all be described in detail later.

When the game is started, an initialization occurs. Preferably, the level is set to 1 and the players “lives” as shown in the lives indicator 28 are set to 3. A predetermined amount of rows of objects 18 is initially placed at the bottom of the grid 12. Preferably, the rows are complete, however a random arrangement may also be used. When the game beings,player input controls the cursor 20.

Independent of player input moving the cursor 20, three processes are generally ongoing and are preferably performed periodically. First, objects of the same type (e.g. diamonds) are deleted when adjacently lined up in a horizontal or vertical line of three or more objects. This is continually checked for objects that are of “matchable” type, that is, objects for which this rule is valid. It should be noted that combinations of such horizontal and vertical lines are also deleted, that is, an L-shaped combination consisting of two vertically arranged objects and two horizontally arranged objects joined by a fifth object is a valid combination. Preferably, all object types are matchable except for one or two (squares, and the later-described optional transformable objects), which are “unmatchable”. According to the second ongoing process, all objects 18 in the grid 12 are moved down (direction of arrow 32) by one cell, simulating a gravity-like effect of falling objects, if there is no object below them. That is, while FIG. 1 illustrates a stable situation where no objects are to be moved down in this way, if an object in the bottommost row were to be deleted, all objects above it would fall according to this requirement. It should be noted, that the cursor 20 is treated as an object and is moved downward according to this falling rule. Third, a new object is periodically placed into the new object row 22, and when the row 22 becomes full, it is shifted up into the playing grid 12. When this occurs, all objects 18 in the playing grid are shifted up to accommodate the new row of objects. The new object row 22 is then empty and the filling of objects begins again. A key or command can be provided to the user to temporarily speed the creation of objects in the new object row 22, such that if the player is waiting for objects to be created, they can press the key or issue the command to force an object to be created. All three of these processes are performed in a timed environment, as mentioned. For example, at each program cycle, the game method checks the arrangement of objects 18 for horizontal or vertical lines of three or more like objects and deletes any objects forming such a line. And, at each timer count (which can be the same as a program cycle) the game method checks objects 18 from bottommost row to topmost row and moves any object not having another object below to simulate falling, and adds a single object into the new object row 22 or shifts the new object row 22 up into the grid 12.

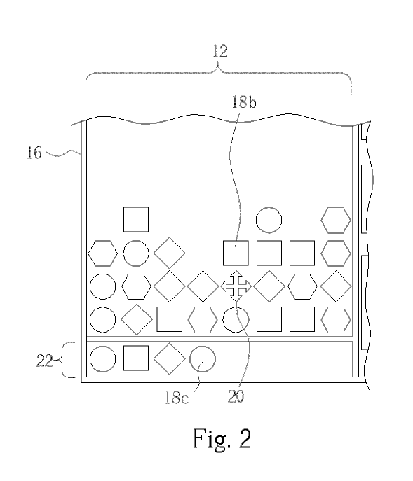

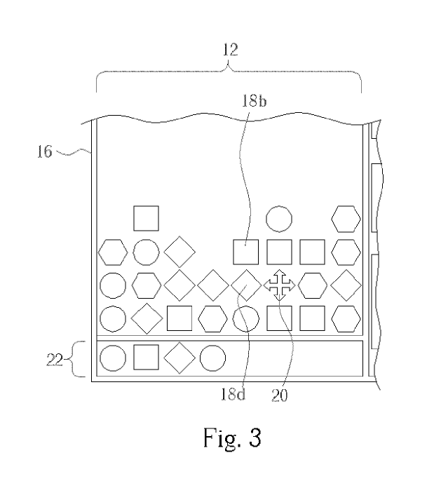

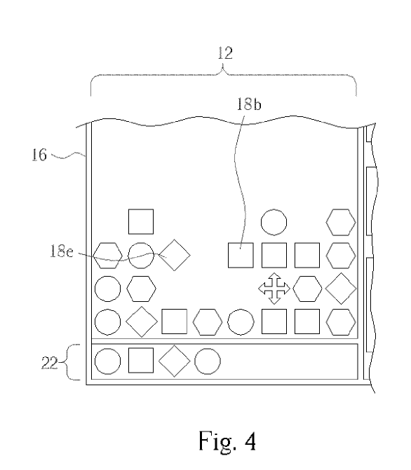

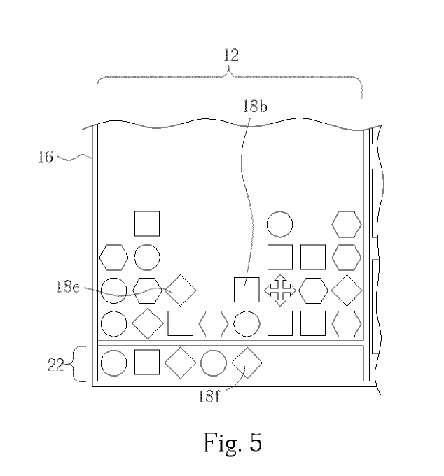

FIG. 2 through FIG. 5 illustrate the movement of the cursor 20 in the grid 12 and the previously described three on-going processes. In FIG. 2, the player has moved the cursor 20 down from the position illustrated in FIG. 1, and accordingly the positions of the cursor 20 and square 18b have been exchanged. Note that since squares are unmatchable objects, the horizontal line of three squares completed by the square 18b is not deleted. In addition, a new object, a circle 18c, has been appended onto the end of the new object row 22. In FIG. 3, the cursor 20 has been moved to the right exchanging positions with the diamond 18d. At this point, the horizontal line of three diamonds completed by the diamond 18d is to be deleted, however, it is still shown for illustrative purposes. Preferably, such a line of objects would be deleted immediately after being formed. FIG. 4 illustrates the horizontal line of three diamonds deleted. Two objects, the square 18b and a diamond 18e, are now constrained to move downwards by the second (falling) process described above. FIG. 5 illustrates the square 18b and diamond 18e having been moved down. In addition, a new object, a diamond 18f, had been added to the new object row 22. Moreover, the cursor 20 need not be constantly moved, and FIG. 5 illustrates the cursor 20 in the same position as in FIG. 4.

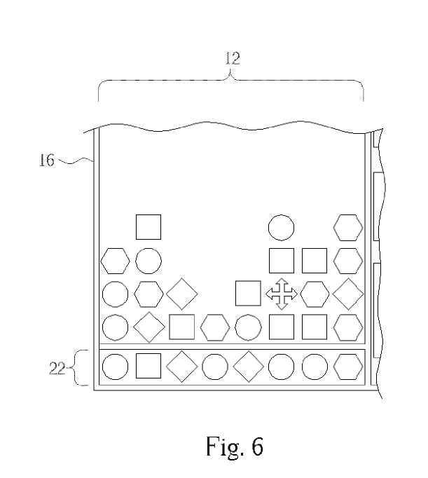

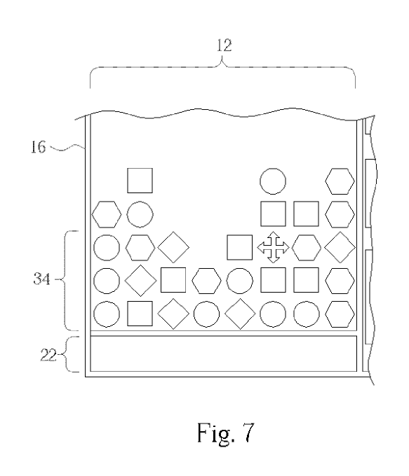

FIG. 6 and FIG. 7 illustrate objects in the new object row 22 being shifted into the playing grid 12. FIG. 6 shows the playing grid 12 at a state sometime after the state shown in FIG. 5. At this time, the new object row 22 is completely filled with objects. FIG. 7 shows the state immediately after that of FIG. 6. All objects in the new object row 22 have been shifted up into the playing grid 12, and accordingly, all objects in the grid 12 including the cursor 20 have bee shifted up to accommodate this new row. In addition, it should be apparent that a newly formed vertical line of three circles 34 will be deleted according to the deletion process.

Next, the levels of the game are described. At the beginning of each level, a target amount of objects to be deleted is set. Each time objects are deleted, the target amount is reduced by the amount of objects deleted. When the target reaches (including going below) zero the level is increased and the target is set accordingly. Each time the target is set, it is preferably set to a value higher than the last value to which it was set. Thus, a set of progressively harder levels is established. To facilitate further challenge, the rate at which new objects are added to the new object row 22 is a function of the game level. That is, the time interval at which new objects are added in shortened as the level increases. For example, referring to FIG. 1, the level indicator 24 indicates level 2, and the target indicator 26 shows that 9 more objects need to be deleted to advance the level to 3. Given this, if the player arranges a horizontal line of 3 diamonds, a vertical line of 4 circles, and a horizontal line of 3 hexagons, the target as shown in the indicator 26 will have values of 9, 6, 2, and −1 (−1 can be illustrated as 0). When the target reaches −1, the level will then be advanced and a value of 3 will be shown in the indicator 24. As a reward to the player for completing a level, unmatchable objects (i.e. squares) are deleted, with the remaining objects falling according to the previously described falling process. Preferably, the levels begin at 1 and advance to a suitably high number (e.g. 99).

Next, the number of attempts and ending the game are described. At the beginning of the game, the player is given a predetermined number of attempts or “lives”, preferably 3. Each time the objects 18 are shifted up such that one or more topmost objects would be shifted up out of the grid 12, the current number of lives is reduced. The when all attempts are used, that is the number of lives is zero, the game ends. The lives are illustrated as hearts in the lives indicator 28 of FIG. 1. The shaded hearts identify two remaining lives and the un-shaded heart indicates a used life, or a failed attempt.

The above describes the major elements of the “novice” mode of the game method. For increased challenge, the present invention includes provisions for an “expert mode”. Before the game is started, a player can select the “expert mode” or the above described“novice mode”. Two elements are added to the “novice mode” to realize the “expert mode”.

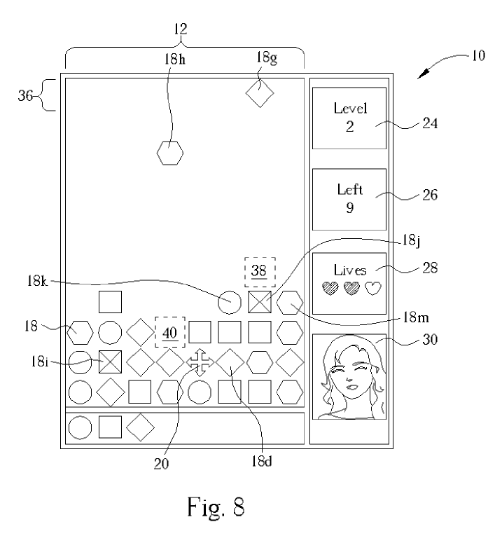

The first element added in the expert mode is introducing new objects at the topmost row of the playing grid 12. Referring to FIG. 8, these new objects are constrained by the previously described falling process to move to lower rows until reaching a cell that is directly above another object. In FIG. 8, a diamond object 18g has just been created in the topmost row 36, while another object 18h, a hexagon, was created several timer counts before and has since advanced to a lower row. If the state of all other objects in the grid 12 remains unchanged, the diamond 18g and hexagon 18h will advance to lower rows until finally coming to rest in cells 38 and 40 respectively.

The second element added in the expert mode is transformable objects. Transformable objects are capable of being transformed into a randomly selected matchable object (circle, diamond, hexagon). The transformation of a transformable object can be initiated through one of two rules (either or both can be implemented). According to the first rule, when an adjacent object in the same row (horizontally adjacent) is deleted, the transformable object is converted into a random matchable object. For example, in FIG. 8 a transformable object 18i would be transformed into a random matchable object if the player moved the cursor 20 rightward to exchange positions with the diamond 18d to complete the horizontal line of three diamonds. When these three diamonds are deleted, the transformable object is changed into a matchable object. According to the second rule, when the transformable object does not have two objects immediately horizontally adjacent, it is converted into a random matchable object. For example, a transformable object 18j would be transformed into a random matchable object if either the circle 18k or the hexagon 18m were moved such that the transformable object 18j had at least one horizontally adjacent empty cell. It should be noted that, preferably, transformable objects are not themselves matchable. That is, three or more transformable objects in a horizontal or vertical line are not deleted according to the ongoing object deletion process.

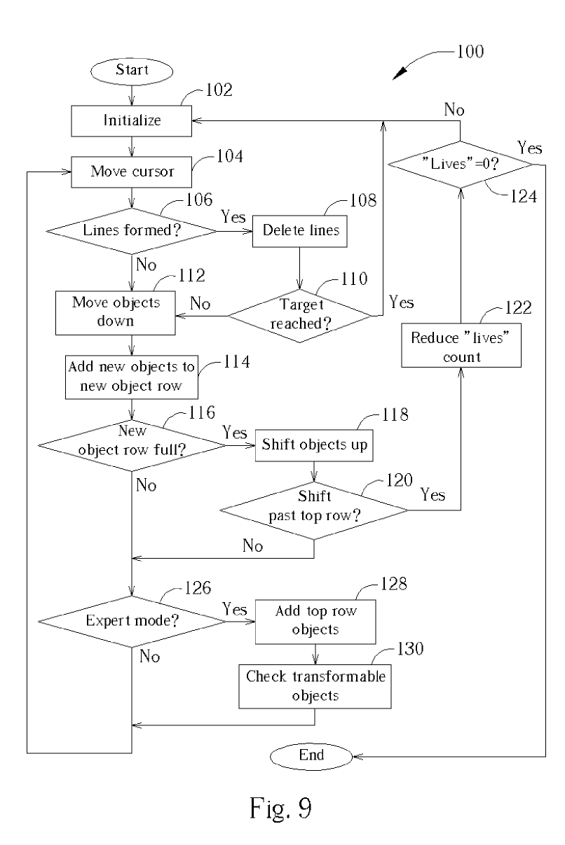

FIG. 9 shows a flowchart 100 illustrating operation of the present invention game method. After an initialization step 102, in which the initial objects of the current level are placed and the players block-deleting target is set, the method detects for player input and moves the cursor 20 accordingly in step 104. Then, in step 106, the method detects if any lines of identical matchable horizontal or vertical objects exist anywhere in the playing grid 12. If there are any such lines formed they are deleted in step 108, and the players target is reduced and score increased accordingly. Step 110 causes re-initialization of the game method at a higher level when the players target is reached. If the target is not yet reached or no lines were formed, the method continues with step 112 moving downward any object not having another object directly below it and not being in the bottommost row. Then, in step 114, a new object is created in the new object row 22. The method checks if the new object row 22 is full in step 116, and shifts the row into the grid 12 in step 118 if it is. After (or while) a new row has been shifted into the grid 12 and all other objects in the grid 12 have been shifted up accordingly, the method determines if any object is to be shifted up past the bounds of the grid 12 in step 120. When an object is to be shifted up past the bounds of the grid 12, the player has lost an attempt. Accordingly, the “lives” count is reduced in step 122 and the game ending condition of “lives” equaling zero is checked in step 124 before the level is reinitialized in step 102. After the new object is added to the new object row in step 114 and if the player has not failed an attempt (lost a “life”), the method conditionally (step 126) performs expert mode functions in steps 128 and 130. In step 128, there is a chance that one or more objects are randomly created in the topmost row of the grid 12. Then, in step 130, the locations and states any transformable objects are checked and transformable objects are converted into matchable ones. Finally, the method returns to step 104 for the subsequent program cycle. It should be noted that not all steps of the flowchart 100 need to be performed every program cycle. For example, Steps 114 and 116 can be performed once every several program cycles depending on the level to slow the introduction of new objects.

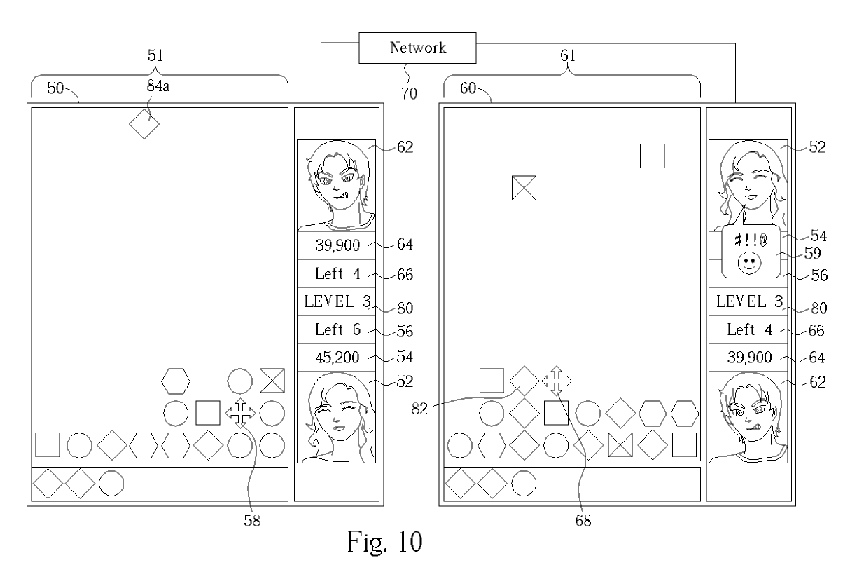

The present invention game method is also suitable for play by multiple players. In the “multiplayer mode”, two versions of the above described novice or expert game are linked by a communications device such as a computer or mobile phone network. FIG. 10 illustrates such a configuration of two identical and independent games 50 and 60 linked by a network 70. The network 70 can be a mobile phone network, a computer network (LAN), an infrared connection, or any other data-exchanging environment. Furthermore, the network 70 can include a separate server to coordinate information exchanges between the games 50, 60, however, one of the games 50, 60 can itself act as the server. The first game 50 includes a playing grid 51 similar to the playing grid 12 of FIG. 1, a cursor 58 moveable by a first player, a first player portrait 52, a first player score 54, and a first player target indicator 56. Similarly, The second game 60 includes a playing grid 61, a cursor 68 moveable by a second player, a second player portrait 62, a second player score 64, and a second player target indicator 66. The cursors 58, 68 can be moved by the respective player to manipulate objects in the respective playing grids 51, 61. Each game 50, 60 also outputs the portrait, score, and target indicator to the other player through the network 70. So, while the first player can see her own information such as her target indicator 56, she can also see the information of the other player such as his score 64. However, each game 50, 60 does not receive information about the other games playing grid such that players cannot know the exact situation of their opponent. In addition to the above-described features, there are three additional features in the multiplayer mode.

The first additional multiplayer feature occurs when one player completes a horizontal or vertical line (or combination) of identical matchable objects. As in the single player mode, such a line is deleted. However, in addition, a random object is created at the topmost row of the playing grid of the other player. For example, in FIG. 10 the second player has just moved the cursor 68 to complete a vertical line of diamonds 82. When the line of diamonds 82 is deleted, the game 60 outputs a signal to the game 50 through the network 70 so that a random object 84a (a diamond) is created in the first players playing grid 51, the diamond 84a subsequently falling according to the ongoing falling process. Additionally, the target of the player completing a line is reduced as previously described, and the score of that player is increased. In this way, a competitive playing environment is realized.

The second additional multiplayer feature is that when one player completes a level, both players advance to the new level and the player completing the level is awarded. As previously described, a level is completed when a player reduces his or her target to zero. The award for completing a level is that unmatchable objects (i.e. squares) are deleted from the completing players playing grid (transformable objects, although unmatchable, are preferably not deleted). The other player is then penalized by having to advance to the more difficult level without having unmatchable objects deleted. For example, if the first player were to move her cursor 58 to form lines such that four objects were deleted, she would advance both players to level 4 and cause all squares in the playing grid 51 to be deleted, with squares in the opponents grid 61 not being deleted. Both players play at the same level as displayed by the level indicator 80.

The third additional multiplayer feature is that words and/or pictures can be exchanged by the two players through the games 50, 60 and the network 70. This is illustrated in FIG. 10 by a communication bubble 59 temporarily obstructing the first players score and target displays 54, 56. That is, the first player has input a message text and picture though an interface (keypad, joystick, touchpad, etc) of the game 50. The message is then displayed to the second players game 60 as the bubble 59. In this way, competitive communication is realized between the two players.

The present invention game method can best be realized as a software program written in a programming language such as Java or C. Modern portable devices such as mobile phones and PDAs have the capability to execute such code, and platforms for programming in theses languages are readily available. Regarding the multiplayer network 70, code required by a server (if necessary) is best written in C.

In contrast to the prior art, the present invention game method is well adapted for simple and exciting play on a mobile device. In addition to being used for entertainment, the computer game method can be used as an intelligence test or as a test of hand-eye coordination. The multiplayer element of the game method allows for remote competition between two players.

Those skilled in the art will readily observe that numerous modifications and alterations of the device may be made while retaining the teachings of the invention. Accordingly, the above disclosure should be construed as limited only by the metes and bounds of the appended claims.

1. A method for a computer game, the method comprising:
providing a playing grid comprising rows and columns of cells, each of the plurality of cells capable of holding an object, each object having a type;
providing a cursor occupying one cell, when the cursor is moved toward an object adjacent to the cursor, the cursor exchanges positions in the grid with the adjacent object;
deleting horizontally or vertically lined-up objects of the same type when the number of the lined-up objects of the same type is equal to a second number;
moving each object in the grid to a cell adjacent to and below the object unless that cell is occupied by another object or the object is in the bottommost row;
creating a new row of objects below the bottommost row of the playing grid; and
shifting the new row of objects up into the grid and shifting all other objects in the grid up to accommodate the new row.

2. The method of claim 1 further comprising:
deleting horizontally or vertically lined-up objects of the same type when the number of the lined-up objects of the same type is more than the second number and the type is matchable.

3. The method of claim 1 further comprising the step of initializing the playing grid by providing a first number of objects in the playing grid, and the first number of initially provided objects are in the bottommost rows and each is of randomly selected type.

4. The method of claim 3 further comprising:
initially providing a predetermined number of lives;
reducing the number of lives by one when any object is to be shifted above the topmost row, and subsequently reinitializing the playing grid by erasing all objects in the grid and then providing the first number of objects in the grid; and
ending the game when the number of lives is equal to zero.

5. The method of claim 1 wherein creating the new row of objects comprises:
periodically sequentially appending an object of randomly selected type to an end of the new row, without moving objects already in the new row, until the new row is full.

6. The method of claim 5 wherein periodically appending an object is according to a timer capable of being over-ridden by a received command.

7. The method of claim 1 wherein in order to be moved, the cursor must exchange positions with an adjacent object.

8. The method of claim 1 wherein the types of objects comprise a plurality of matchable object types and an unmatchable object type.

9. The method of claim 8 further comprising:
decreasing a target value when deleting horizontally or vertically lined-up objects of the same type.

10. The method of claim 9 further comprising:
deleting all unmatchable objects when the target value reaches zero, and subsequently setting target value.

11. The method of claim 10 wherein the target value is decreased by an amount equal to the amount of objects deleted, and the target value is set according to number of times that the target has been previously reached.

12. The method of claim 8 wherein the types of objects further comprise transformable objects, the method further comprising:
transforming each transformable object into a matchable object when an adjacent cell in the same row as the transformable object is empty.

13. The method of claim 8 wherein the types of objects further comprise transformable objects, the method further comprising:
transforming each transformable object into a matchable object when an adjacent object in the same row as the transformable object is deleted.

14. The method of claim 1 further comprising:
creating an object of randomly selected type in a cell of the topmost row of a randomly selected column at a random interval.

15. The method of claim 1 wherein two independent playing grids, a playing grid and an other playing grid, and corresponding cursors are provided for two players, the steps of the method being executed independently for each playing grid and each cursor; the method further comprising:
creating at least an object of randomly selected type in a cell of the top most row of a randomly selected column of the playing gird when deleting horizontally or vertically lined-up objects of the same type in the other playing grid.

16. The method of claim 15 further comprising:
deleting horizontally or vertically lined-up objects of the same type when the number of the lined-up objects of the same type is more than the second number and the type is matchable;
wherein when creating at least an object of randomly selected type in the playing grid, the number of objects created is proportional to the number of objects deleted in the other playing grid.

17. The method of claim 15 wherein the types of objects comprise a plurality of matchable object types and an unmatchable object type.

18. The method of claim 17 further comprising:
decreasing a target value when deleting horizontally or vertically lined-up objects of the same type.

19. The method of claim 18 further comprising:
deleting all unmatchable objects in the playing grid when the target value reaches zero, and subsequently setting the target value; wherein unmatchable objects in the other playing grid are not deleted.

20. The method of claim 19 wherein the target value is decreased by an amount equal to the amount of objects deleted, and the target value is set according to number of times that the target has been previously reached.

21. The method of claim 15 further comprising: providing a message input means; and displaying near the playing grid a message inputted at the other playing grid by the other player; wherein a message is text or a picture.
